(19) United States
(12) Patent Application Publication
(10) Pub. No.: US 2004/0080061 A1
(43) Pub. Date: Apr. 29, 2004

(54) Method and apparatus of forming color elements for a color filter

(75) Inventors: Hsin-An Cheng, Kaohsiung Hsien (TW); Kuang-Lung Kuo, Taoyuan (TW); Sheng-Shiou Yeh, Miaoli (TW); Tzu-Seng Yang, Hsinchu (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/410,370

(22) Filed: Apr. 9, 2003

(30) Foreign Application Priority Data
Oct. 25, 2002 (TW) 91125209

(51) Int. Cl. G02B 5/20

(52) U.S. Cl. 264/1.1; 425/90

(57) ABSTRACT

A method of forming color elements for a color filter and an apparatus for the same. A color arrangement of color elements for a color filter is provided on a die plate. Then, a plurality of bumps is formed on the die plate corresponding to the color arrangement of color elements. Next, a plurality of pigments is provided to the bumps respectively to form a plurality of color bumps. Finally, the color bumps of the die plate are downwardly stamped on a transparent insulating substrate to form a plurality of color elements corresponding to the color arrangement.

### BACKGROUND OF THE INVENTION

1. Field of the Invention

The invention relates to a color filter technology, and more particularly to a method of forming color elements for a color filter and an apparatus for the same.

2. Description of the Related Art

As scientific technologies and information advance, color filters (CF) have been popularly used in video products, such as color liquid crystal displays, and charge coupled devices and scanners, to obtain plentiful color information. With regard to a liquid crystal display (LCD) with light, thin, power-saving and full color features, including super-twisted-nematic (STN) type, thin-film-transistor (TFT) type and metal-insulator-metal (MIN) type, a color filter with three primary colors including red (R), green (G) and blue (B) elements is needed to divide a pixel into R, G and B subpixels. The three primary colors are blended with each other in proportion to create various colors, thus enabling the LCD to display bright, realistic and vivid pictures, enhancing functionality of the LCD.

In a conventional CF process, thin-film color layers including R, G and B layers are successively coated on a glass substrate to serve as R elements, G elements and B elements, after which the R, G and B elements must be precisely aligned to pixel areas on the TFT array substrate. In view of manufacturing costs and quality requirements, dyeing, pigment dispersion, printing and electroplating are commonly used to form the R, G and B elements of the color filter. Particularly, pigment dispersion that provides the color filter with high precision and superior light- and heat-resistance has become a major process in recent TFT-type color filter technologies. Pigment dispersion comprises three key procedures of color-photoresist coating, interval-alignment exposure, and development, but poor uniformity in the color-photoresist layers caused by conventional coating techniques must be overcome. Although ink jet and printing have been applied to improve the uniformity of the color photoresist layers, problems of poor resolution and misalignment are concurrently generated. As for electroplating, a multi-level mask is used to form fine and precise patterns of the R, G and B elements on a color filter, but limitations in manufacturing a needed and specific photoresist layer and difficulties in obtaining the multi-level mask impede commercialization.

R.O.C. Patent No. 479147 discloses a method of forming a color filter, in which an inkjet head is used in scanning motion to complete R, G and B elements in strip arrangement, and FIG. 1 is a schematic diagram of the apparatus for patterning the color elements. First, selecting a reference filter, optical effects and aperture size of each pixel on the reference filter are determined, calculated, and corrected to provide a designed pattern. Then, using an image treatment device 10, the designed pattern is conveyed to a pattern information generator 12, and then individual signals are conveyed to a driver 14. Next, driving signals are conveyed to a plurality of inkjet heads 16R, 16G and 16B and feeding devices 18 and 20. In patterning the R, G and B elements, a substrate 24 is fixed on a movable platform 22, the movement of which toward X and Y directions can change corresponding positions between the substrate 24 and the inkjet heads 16R, 16G and 16B so as to print a color arrangement 26 on the substrate 24. However, this requires complicated measurement, complex operations, and expensive facilities, thus generating problems for mass production.

### SUMMARY OF THE INVENTION

Accordingly, an object of the invention provides a method of forming color elements for a color filter and an apparatus for forming the same, to stamp color bumps of a die plate on a transparent insulating substrate to complete color elements.

To achieve these and other advantages, the invention provides a method of forming color elements for a color filter and an apparatus for forming the same. A color arrangement of color elements for a color filter is provided on a die plate. Then, a plurality of bumps is formed on the die plate corresponding to the color arrangement of color elements. Next, a plurality of pigments is provided to the bumps respectively to form a plurality of color bumps. Finally, the color bumps of the die plate are downwardly stamped on a transparent insulating substrate to form a plurality of color elements corresponding to the color arrangement.

Moreover, at least three replenishing devices are provided on the die plate. Each replenishing device comprises a pigment-injecting opening and a plurality of pigment-replenishing channels. One end of each pigment-replenishing channel is connected to others and the pigment-injecting opening, and the other ends of each pigment-replenishing channel are connected to corresponding color bumps. A first pigment is provided to the pigment-injecting opening of a first replenishing device, in which the first pigment flows through the pigment-replenishing channels to reach a plurality of first color bumps. A second pigment is provided to the pigment-injecting opening of a second replenishing device, in which the second pigment flows through the pigment-replenishing channels to reach a plurality of second color bumps. A third pigment is provided to the pigment-injecting opening of a third replenishing device, in which the third pigment flows through the pigment-replenishing channels to reach a plurality of third color bumps.

### DESCRIPTION OF THE DRAWINGS

For a better understanding of the present invention, reference is made to a detailed description to be read in conjunction with the accompanying drawings, in which:

FIG. 1 is a schematic view showing an inkjet head for printing color elements according the prior art.

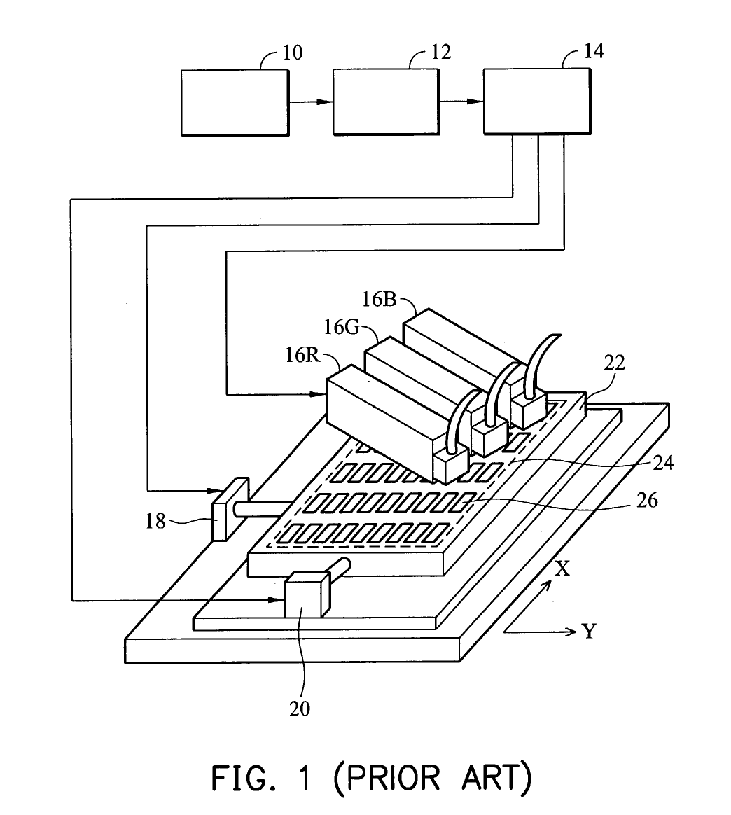

FIGS. 2A to 2C are top views showing trip-type, mosaic-type and delta-type arrangements of color elements for a color filter according to the present invention.

FIG. 3 is a sectional view showing a plurality of bumps on a die plate according to the present invention.

FIGS. 4A and 4B are sectional views showing color bumps on a die plate according to the present invention.

FIG. 5 is a schematic view showing color elements on a transparent insulating substrate according to the present invention.

### DETAILED DESCRIPTION OF THE INVENTION

The present invention provides a stamping method of forming color elements for a color filter and an apparatus for forming the same. A predetermined arrangement of color elements are formed as a plurality of bumps on a die plate, and then appropriate pigments are provided to the bumps respectively. Next, stamping the bumps on a transparent insulating substrate, the color arrangement on the die plate is transferred to the transparent insulating substrate.

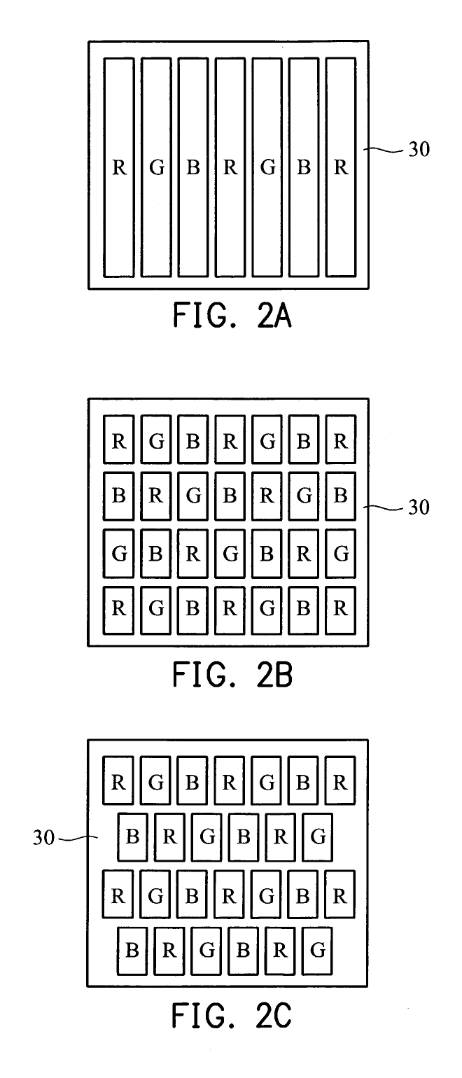

A preferred embodiment of the present invention is now described with reference to FIGS. 2 through 5.

In FIGS. 2A to 2C, a predetermined arrangement of color elements for a color filter is provided to form red areas R, green areas G and blue areas B on a die plate 30 according to demands of process and products. Recently, the developed arrangements comprise a trip type as shown in FIG. 2A, a mosaic type as shown in FIG. 2B, and a delta type as shown in FIG. 2C. The trip-type arrangement provides high-density and varied appearance for a picture, and is thus mostly applied to computer screens. The delta-type arrangement provides a simplified driving and an optimum blend-mode effect, and is thus popularly applied to small-scale screens. The die plate 30 is rubber or stainless steel.

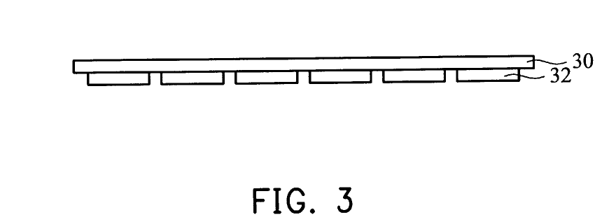

Next, in FIG. 3, in accordance with the above-described arrangement of color elements, a plurality of bumps 32 corresponding to the red areas R, green areas G and blue areas B are formed on the die plate 30. In order to improve stamping properties, the thickness uniformity of the bumps 32 must be well controlled, and the bump 32 must be rubber or other flexible material. The size, profile and amount of the bump 32 and methods of forming the same can be appropriately modulated depending on demands of process, such that the design choices of the bump 32 are not further limited.

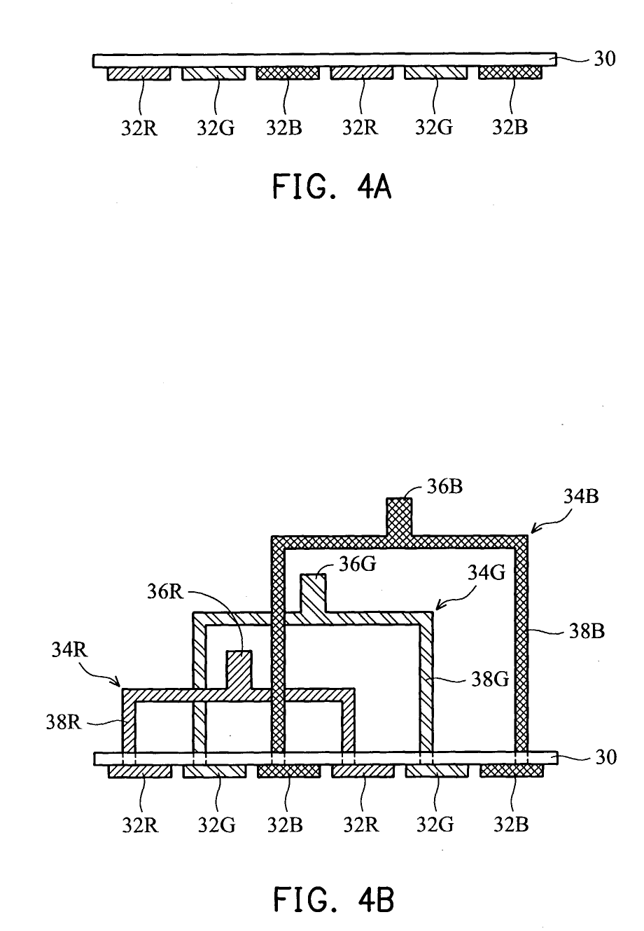

Subsequently, in FIGS. 4A and 4B, appropriate pigments are provided to the bumps 32 respectively to produce a plurality of red bumps 32R, green bumps 32G and blue bumps 32B. In one method of providing pigment, as shown in FIG. 4A, the R, G and B pigments are directly coated on the red bumps 32R, green bumps 32G and blue bumps 32B, respectively. However, this can waste time and encounter poor uniformity in the coating pigments. Another way of providing pigments, as shown in FIG. 4B, is to form three replenishing devices 34R, 34G, and 34B not connected to each other, on the die plate 30. Each of the three replenishing devices 34 comprises a pigment-injecting opening 36 and a plurality of pigment-replenishing channels 38, in which one end of each pigment-replenishing channel 38 is connected to others and to the pigment-injecting opening 36, and the other ends of each pigment-replenishing channel 38 are connected to corresponding bumps 32. For example, the red replenishing device 34R comprises a red pigment-injecting opening 36R and a plurality of red pigment-replenishing channels 38R, in which one end of each red pigment-replenishing channel 38R is connected to others and to the red pigment-injecting opening 36R, and the other ends of each red pigment-replenishing channel 38R is respectively connected to red bumps 32R. Similarly, the green replenishing device 34G comprises a green pigment-injecting opening 36G and a plurality of green pigment-replenishing channels 38G, and the blue replenishing device 34B comprises a blue pigment-injecting opening 36B and a plurality of blue pigment-replenishing channels 38B. Thus, controlling quantities of the replenished pigments in the replenishing devices 34, the thickness and uniformity of color elements are well controlled to meet demands for color tones.

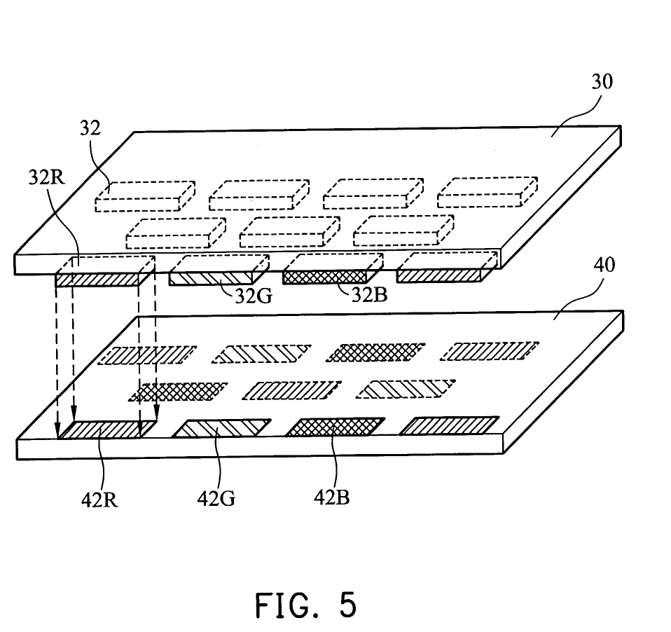

Finally, in FIG. 5, using single stamping or repeated stamping depending on the size of the die plate 30 and the number of the bump 32, the red bumps 32R, green bumps 32G and blue bumps 32B on the die plate 32 are downwardly stamped on a transparent insulating substrate 40, resulting in color elements 42 including red elements 42R, green elements 42G and blue elements 42B.

Compared with conventional methods of using pigment dispersion and inkjet printing to form a color filter, the present invention stamps the color bumps 32 of the die plate 30 on the transparent insulating substrate 40 to form red elements 42R, green elements 42G and blue elements 42B. This has advantages of simplified process, high yield, efficient use of pigments, and low facility costs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of forming color elements for a color filter, comprising the steps of:
providing a color arrangement of color elements for a color filter;
patterning the color arrangement on a die plate;
forming a plurality of bumps on the die plate, in which the bumps correspond to the color arrangement of color elements;
providing a plurality of pigments to the bumps respectively to form a plurality of color bumps; and
stamping the color bumps of the die plate downwardly on a transparent insulating substrate to form a plurality of color elements corresponding to the color arrangement.

2. The method of forming color elements for a color filter as claimed in claim 1, wherein the color arrangement is a strip-type arrangement.

3. The method of forming color elements for a color filter as claimed in claim 1, wherein the color arrangement is a mosaic-type arrangement.

4. The method of forming color elements for a color filter as claimed in claim 1, wherein the color arrangement is a delta-type arrangement.

5. The method of forming color elements for a color filter as claimed in claim 1, wherein the die plate is rubber or stainless steel.

6. The method of forming color elements for a color filter as claimed in claim 1, wherein the bump is rubber or other flexible material.

7. The method of forming color elements for a color filter as claimed in claim 1, wherein the bumps have the same thickness.

8. The method of forming color elements for a color filter as claimed in claim 1, wherein the step of providing pigments to the bumps further comprises:
providing at least three replenishing devices, in which each replenishing device comprises a pigment-injecting opening and a plurality of pigment-replenishing channels, one end of each pigment-replenishing channel connected to others and the pigment-injecting opening, and the other end of each pigment-replenishing channel connected to corresponding color bumps;
providing a first pigment to the pigment-injecting opening of a first replenishing device, in which the first pigment flows through the pigment-replenishing channels to reach a plurality of first color bumps;
providing a second pigment to the pigment-injecting opening of a second replenishing device, in which the second pigment flows through the pigment-replenishing channels to reach a plurality of second color bumps; and
providing a third pigment to the pigment-injecting opening of a third replenishing device, in which the third pigment flows through the pigment-replenishing channels to reach a plurality of third color bumps.

9. An apparatus for forming color elements for a color filter, comprising:
a die plate, on which a color arrangement of color elements for a color filter is patterned; and
a plurality of color bumps on the die plate, in which the color bumps corresponds to the color arrangement of color elements.

10. The apparatus for forming color elements for a color filter as claimed in claim 9, further comprising:
a first replenishing device comprising a pigment-injecting opening and a plurality of pigment-replenishing channels, in which one end of each pigment-replenishing channel is connected to others and the pigment-injecting opening, and the other ends of each pigment-replenishing channel are connected to a plurality of first color bumps;
a second replenishing device comprising a pigment-injecting opening and a plurality of pigment-replenishing channels, in which one end of each pigment-replenishing channel is connected to others and the pigment-injecting opening, and the other ends of each pigment-replenishing channel are connected to a plurality of second color bumps; and
a third replenishing device comprising a pigment-injecting opening and a plurality of pigment-replenishing channels, in which one end of each pigment-replenishing channel is connected to others and the pigment-injecting opening, and the other ends of each pigment-replenishing channel are connected to a plurality of third color bumps.

11. The apparatus for forming color elements for a color filter as claimed in claim 9, wherein the color arrangement is a strip-type arrangement.

12. The apparatus for forming color elements for a color filter as claimed in claim 9, wherein the color arrangement is a mosaic-type arrangement.

13. The apparatus for forming color elements for a color filter as claimed in claim 9, wherein the color arrangement is a delta-type arrangement.

14. The apparatus for forming color elements for a color filter as claimed in claim 9, wherein the die plate is rubber or stainless steel.

15. The apparatus for forming color elements for a color filter as claimed in claim 9, wherein the color bump is rubber or other flexible material.

16. The apparatus for forming color elements for a color filter as claimed in claim 9, wherein the color bumps have the same thickness.
